(19) United States
(12) Patent Application Publication
(10) Pub. No.: US 2008/0320566 A1
(43) Pub. Date: Dec. 25, 2008

(54) Device provisioning and domain join emulation over non-secured networks

(75) Inventors: Shai Herzog, Bellevue, WA (US); Paul Cotter, Monroe, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/821,686

(22) Filed: Jun. 25, 2007

(51) Int. Cl. H04L 9/32; H04M 1/66

(52) U.S. Cl. 726/4; 455/411

(57) ABSTRACT

Proxy service that enables a domain join operation for a client over a non-secure network. The join operation is achieved with minimal security exposure by using machine identity information rather than user credentials. The proxy only uses permission associated with adding a new machine account to the enterprise directory, and not for adding a user account or take ownership of existing accounts. The proxy enables authentication based on actual machine account credentials to obtain a signed certificate, rather than conventional techniques such as delegation. Moreover, the enrollment process employs an original trust relationship between the device and the proxy rather than requiring or depending on public trust.

### BACKGROUND

Corporate computers are typically identified and managed through a community mechanism called “domain” (e.g., in the Microsoft networks), or similar names in non-Microsoft networks (e.g., Novell™ directory, yellow pages, etc.). Membership in a domain is considered mandatory in many corporate installations for the purpose of identifying specific machines and centrally managing machine content (e.g., policy, software, and configuration).

With respect to portable computers such as a laptop, for example, becoming a member of the domain typically requires authorization via authentication credentials such as username and password. After some processing the computer becomes domain joined. Credentials can be manually provided or via a smartcard, for example, which authenticates the user seeking to join the machine to the domain.

Mobile devices present a challenge in this area in that a mobile phone, for example, does not have the technological facilities to perform a domain join operation. Given that a mobile phone is rarely, if ever, used on a corporate network, vendors are slow to provide solutions for such devices. Accordingly, smartcard solutions are cumbersome, and user credentials such as username/password can be compromised if the authentication is not end-to-end.

Domain controllers are considered the heart of security in corporate networks and are expected to be well protected behind a firewall and other isolation mechanisms. Many mobile devices lack the necessary software components to successfully join corporate domains, especially since such devices are oftentimes remote (or outside the perimeter of the corporate Intranet) and have no direct access to corporate domain controllers. The challenge is multifaceted, and includes closing the software gap from the mobile phone to the network as well as performing the join operation securely from outside of the corporate network over the non-secure wireless public interface (over the air or OTA).

### SUMMARY

The following presents a simplified summary in order to provide a basic understanding of novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture comprises an enrollment proxy that facilitates a domain join operation for a mobile client. The proxy is accessible over-the-air (OTA) from the public domain (e.g., the Internet) in which the client operates and fills in the software and connectivity gaps on behalf of a mobile client for joining the client to a private domain. In part, novelty lies in the fact that the Internet-exposed services have no inherent privileges, and compromise thereof represents a significantly reduced risk to the private domain. The architecture introduces the proxy as an intermediate service for facilitating the join operation, and once completed, the proxy is no longer needed to maintain the connection between the client and the private domain.

In a first implementation, a domain join by the proxy is accomplished using only a username and password provided by a user of the mobile device to the proxy. The proxy, on behalf of the mobile client, establishes the account in the private domain. The private domain and the proxy have a trust relationship; however, the proxy reduces the exposure of the private domain to security risks.

In a more robust and secure second implementation, a one-time-password (OTP) is employed. The enrollment proxy enables a domain join operation for a mobile client through the proxy. The join operation is achieved with minimal security exposure. The join operation is based on machine identity of the mobile device, rather than user credentials (e.g., username and password), and therefore, is not a potential risk for compromising user identity information (e.g., identity theft). The enrollment proxy only needs permission to add a new machine account to the enterprise (or corporate) directory; the proxy is not authorized to add a user account or take ownership of existing accounts. The enrollment proxy obtains a signed certificate based on actual machine account credentials, rather than employing conventional techniques such as delegation. The enrollment process employs private root trust between the mobile device and the enrollment server rather than requiring or depending on public trust techniques. Ultimately, the client is granted a machine identity in the private domain company directory (e.g., Active Directory by Microsoft Corporation) and receives a signed public certificate (e.g., X.509, a standard for public key infrastructure) that allows self-authentication as a domain member associated with that account.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented domain membership management system for joining a device to a domain.

FIG. 2 illustrates an alternative system for managing domain membership to a domain.

FIG. 3 illustrates information that is persisted in the domain datastore at least for bootstrap and authentication purposes.

FIG. 4 illustrates a method of managing domain membership.

FIG. 5 illustrates a method of persisting data to a datastore in support of establishing a trust relationship and authentication.

FIG. 6 illustrates a method of preparing authentication information by the device for authenticating the proxy server.

FIG. 7 illustrates a method of enrolling a device by authenticating the proxy.

FIG. 8 illustrates a method of authenticating the client to the proxy.

FIG. 9 illustrates a method of obtaining a certificate after device and proxy authentication.

FIG. 10 illustrates a method of obtaining a certificate for domain enrollment.

FIG. 11 illustrates a block diagram of a computing system operable to provide non-secured provisioning and emulated domain join.

FIG. 12 illustrates a schematic block diagram of an exemplary computing environment that facilitates non-secured provisioning and emulated domain join.

### DETAILED DESCRIPTION

The disclosed architecture provides a single secure mechanism that solves conventional non-secure connectivity and access problems typically associated with a client (e.g., mobile) seeking access to a private domain (e.g., enterprise). The solution comprises of an enrollment proxy that is accessible over-the-air (OTA) on a client in the public network (e.g., the Internet) and based on either user credential or machine credentials, facilitates a domain join operation for the client, and then removes itself from the connection. Ultimately, the client is granted membership in the private domain.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

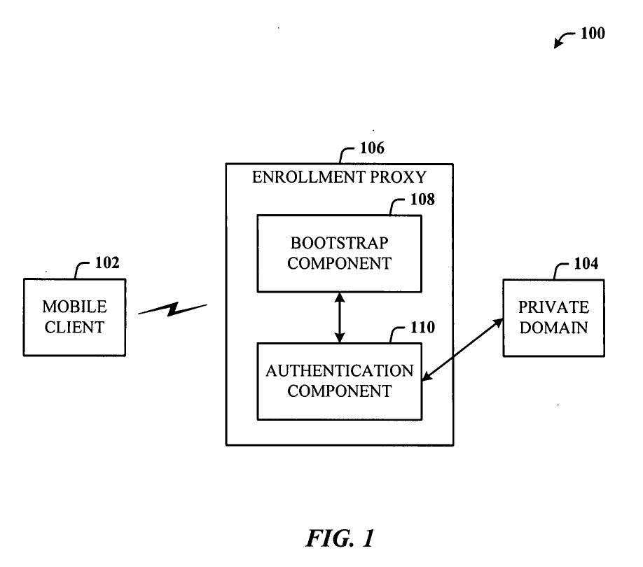

Referring initially to the drawings, FIG. 1 illustrates a computer-implemented system 100 for managing domain membership. The system 100 provides a mechanism for joining a mobile client 102 to a private domain 104 via an enrollment proxy server 106. The proxy 106 provides the interface between the public domain in which the mobile client 102 (e.g., a cell phone) operates, and the private domain 104 (e.g., a corporate enterprise). In this implementation, the domain join is based on user credentials in the form of a username and password provided by a user of the mobile client 102. The proxy 106 is given the username and password, and impersonates the client 102 to the domain 104 in order to join the client 102 to the domain 104.

In support thereof, the proxy 100 includes a bootstrap component 108 for receiving the user credentials from a mobile client 102 and communicating the user credentials to an authentication component 110 of the proxy 106. The authentication component 110 then performs authentication to the private domain on behalf of the client 102 and creates a machine account in the private domain based on the user credentials. There is no request to use a one-time-use password (OTP) or a single-use personal identification number (PIN), as will be used in the following implementation.

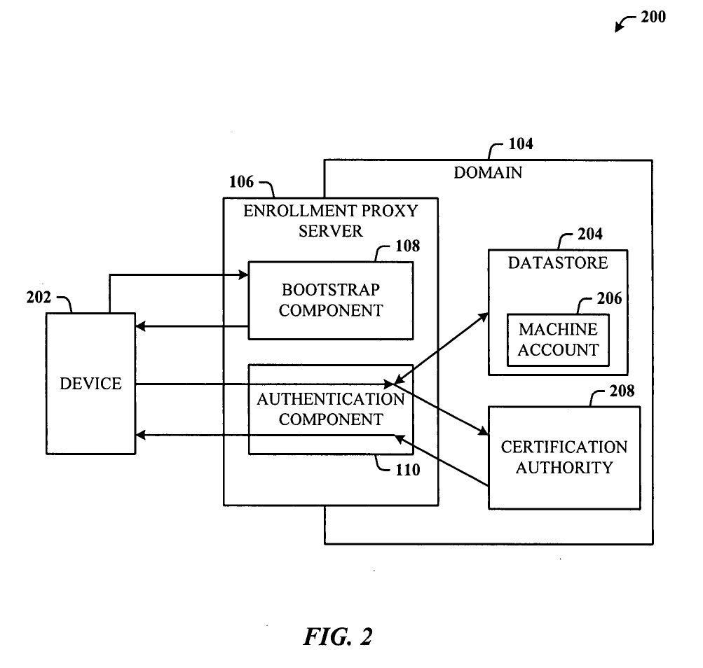

FIG. 2 illustrates an alternative and more robust system 200 for managing membership to a domain. The following begins with a high-level description of the system operation, followed by a detailed description of the processes between the entities.

The system 200 facilitates a two-stage process for joining a device 202 (e.g., mobile, portable computer) to the private domain 104. The first stage is for developing a trust relationship between the device 202 and the proxy 106, referred to hereinafter as the “basic” trust relationship. The basic trust relationship is in itself a two-part process: the device 202 establishes that the proxy 106 is the correct proxy, and the proxy 106 establishes that the device 202 is authorized to connect to the domain 104. Once established, the basic trust relationship no longer requires the proxy 106. The second stage develops a trust relationship between the device 202 and the private domain 104, referred to hereinafter as the “full” trust relationship. Similarly, once established, the full trust relationship no longer requires the proxy 106.

The operation of system 200 is based on other types of credentials such as the OTP (or the PIN), rather than user credentials employed in the system 100 of FIG. 1. For purposes of this description, it is assumed that the user has been provided the OTP in conjunction with prior interaction with the private domain 104 such that both the user and the private domain share the same credentials. The means by which the device user obtains the OTP can be by any conventional secured/unsecured mechanism. If either of the device user or the domain cannot provide (or access) the OTP, the domain join operation terminates.

Generally, interaction begins by establishing the basic trust relationship from the device 202 to the proxy 106. The device 202 checks to ensure that the proxy 106 is the correct proxy. This is accomplished by the device sending a request to the proxy 106 for the corporate trust information. The proxy 106 also generates a cryptographically hashed signature of the trust information, where the hash is generated using a key derived from the previously-defined OTP. By generating the same hash using the OTP on the device 202, the device 202 is able to verify that the proxy 106 is the “correct” proxy for establishment of the basic trust relationship. If the proxy 106 cannot access this credentials server, the proxy 106 is not the “correct” proxy for establishment of the basic trust relationship, and the process ends.

Once the first part of the basic trust relationship from the device 202 to the proxy 106 is established, the second part of the basic trust relationship involves the proxy 106 then checking that the device 202 is one that could be allowed to join the private domain 104. Once this bi-directional basic trust relationship is established between the device 202 and the proxy 106, the proxy 106 acts on behalf of the device 202 to obtain a certificate and generate a machine account that the device can then access. This involves the use of a domain datastore 204 for hosting a machine account 206, and a domain certification authority 208 for issuing a certificate for the full trust relationship to be established.

Before continuing with the more detailed description of the process, it should be understood that certain information is generated in the domain 104 (e.g., in the datastore 204) based upon the OTP provided to the user and also stored in the domain 104. The following information is generated and persisted in the domain: the OTP, an encryption key derived from the OTP, a name for the device machine account 206, a reference to the owner of the device 202 (e.g., an identifier of the owner's datastore account), an identifier of the target container in the datastore 204 for the device's machine account 206, a keyed-hash code (e.g., an HMAC-hashed machine authentication code) digest of a user-identifying string (e.g., the device owner's e-mail address) derived using the above encryption key, and the machine account 206. The datastore 204 can be a file, a database, an application partition, etc. Note also that the digest can be any encryption seed such as a login ID of the user, or the word “anonymous”, for example.

As generally described above, enrollment includes establishing the first part of the basic trust relationship by the device 202 verifying the authenticity of the proxy 106. In order to achieve this, the device 202 passes the HMAC digest to the proxy 106 by calling a web service. This web service uses secure socket layer (SSL) for channel encryption, but does not yet use SSL authentication. The proxy 106 then retrieves the previously-stored encryption key from the datastore 204, and uses the encryption key to create an HMAC digest of the trusted root domain certificate of the proxy's SSL certificate chain. This HMAC digest is passed along with the corresponding root domain certificate to the device 202, which verifies that the HMAC digest was correctly computed by the proxy 106 using the previously-derived encryption key.

Once the device 202 has determined that the domain certificate can be trusted according to the above mechanism, the device 202 reconnects to the same proxy 106, this time using full SSL server authentication with channel encryption. The device 202 reconnects to verify that the server SSL certificate appropriately links (or chains) back to the domain certificate that was previously determined to be trusted. The device 202 then submits a certificate request (e.g., public key cryptography standard (PKCS) number 10), along with an HMAC digest of the certificate request derived using the previously-calculated encryption key. (The PKCS#10 standard certificate request is a format for messages sent to a certificate authority to request certification of a public key.) The proxy 106 verifies that the HMAC digest of the certificate request was derived from the provided certificate request using the previously-derived encryption key, thereby authenticating the device 202.

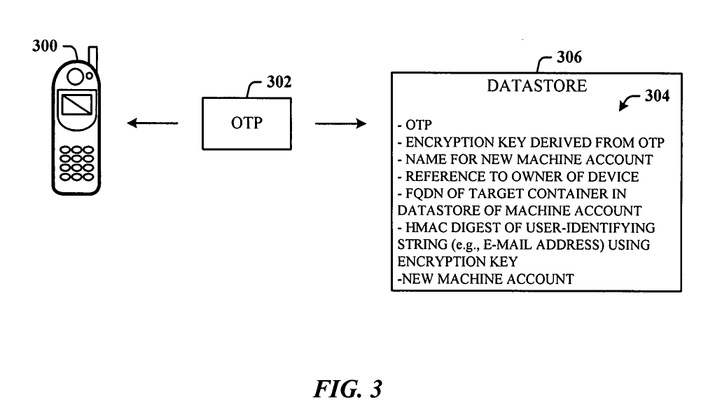

The proxy 106 then uses the datastore information (information 304 of FIG. 3) linked to the HMAC digest to create the new machine account 206 in the datastore 204 (e.g., Active Directory). The new machine account 206 is logged into by the authentication component 110 and used during the log-in to submit the certificate request to the certification authority 208. The issued certificate is then retrieved and returned to the device 202.

Summarizing some of the novel aspects, the enrollment proxy 106 emulates a domain join operation for the device 202. The join operation is based on a one-time-use password, and therefore, is not a potential risk for compromising user identity information. Additionally, the enrollment proxy 106 only needs a minimal level of access to the domain to add a new machine account to the enterprise (or corporate) datastore. Moreover, the enrollment proxy 106 is not authorized to add a user account or take ownership of an existing account. The basic trust relationship developed between the client device 202 and proxy 106 is used by the proxy 106 to ultimately establish the full trust relationship between the device 202 and the private domain 104. The machine identity can be stored in a domain datastore or directory (e.g., Active Directory™ by Microsoft Corporation) and receives a signed public certificate (e.g., X.509) which allows the device 202 to authenticate itself as a member of the private domain 104.

In an optional embodiment, the OTP is used in combination with a unique device identifier (ID) that is hardware specific, such that the identifying information passed to the proxy 106 includes both the OTP and the device ID. This prevents the use of the OTP with other mobile devices the user may have or which can be used by a different user on a different device. In one implementation, based on initial processing of the OTP, either the basic or full trust processing between the device 202 and the proxy 106 can be elevated to include the device ID and then completes the trust process either favorably or unfavorably for the device 202.

FIG. 3 illustrates information that is persisted in the domain datastore 204 at least for bootstrap and authentication purposes. The following description is in the context of a mobile device 300 (e.g., cell phone). However, it is to be understood that portable computers and other wireless devices such as PDAs and tablet PCs can obtain the benefits of the disclosed domain enrollment architecture.

The bootstrapping process is based on the mobile device user having already obtained an OTP 302. The following information 304 is then generated and persisted to an intermediate datastore 306: the OTP 302, an encryption key derived from the OTP, a name for the device machine account 206 (it is assumed that the mobile device 300 is a “new” device relative to the domain, and thus, no previous machine account for the device 300 exists), a reference to the owner of the mobile device 300 (e.g., a fully qualified domain name (FQDN) of the owner's datastore account), a reference to the target container in the datastore 204 for the device's machine account 206, (e.g., the FQDN of the container), a keyed-hash (e.g., an HMAC) digest of a user-identifying string (e.g., the device owner's e-mail address) derived using the above encryption key, and the machine account 206 of FIG. 2.

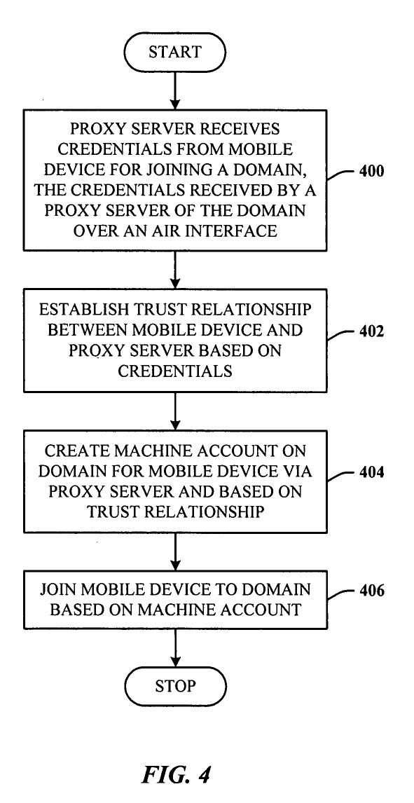

FIG. 4 illustrates a method of managing domain membership. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required for a novel implementation.

At 400, credentials (e.g., OTP) are received from a mobile device for joining a domain, the credentials received by a proxy server of the domain over an air interface. At 402, a trust relationship is established between the mobile device and the proxy server based on the credentials. At 404, a machine account is created in the domain for the mobile device via the proxy server and based on the trust relationship. At 406, the mobile device is joined to the domain based on the machine account.

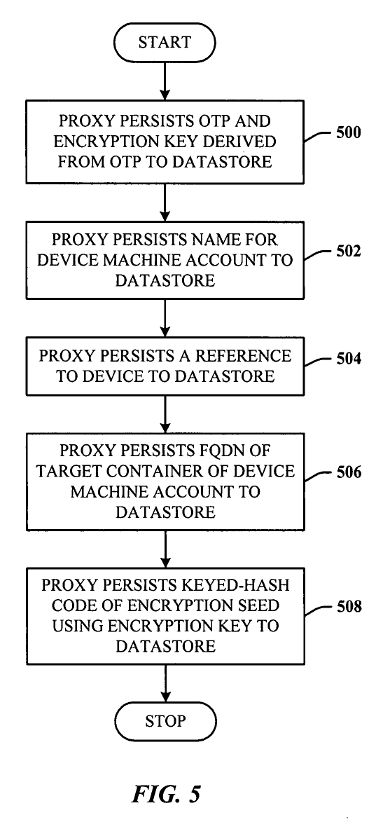

FIG. 5 illustrates a method of persisting data to a datastore in support of establishing a trust relationship and authentication processing. At 500, after the OTP has been generated and assigned to the mobile device user according to other procedures or processes, the proxy persists the OTP and an encryption key to a datastore. At 502, the proxy persists a name for the machine account to the datastore. At 504, the proxy persists a reference to the device (e.g., user-identifying information) to the datastore. At 506, the proxy persists an FQDN of the target container of the device machine account to the datastore. At 508, the proxy persists a keyed-hash code digest of an encryption seed using the above encryption key, to the datastore.

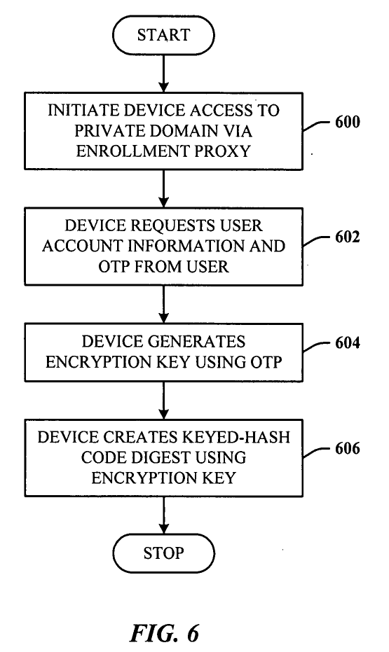

FIG. 6 illustrates a method of generating authentication information by the device for authenticating the proxy server. At 600, the device initiates access to a private domain via the enrollment proxy based on a previously-obtained OTP. At 602, the device prompts the device user for user account information and the OTP. At 604, the device generates an encryption key using the OTP. At 606, the device creates a keyed-hash code (e.g., HMAC) digest of the user account information using the encryption key.

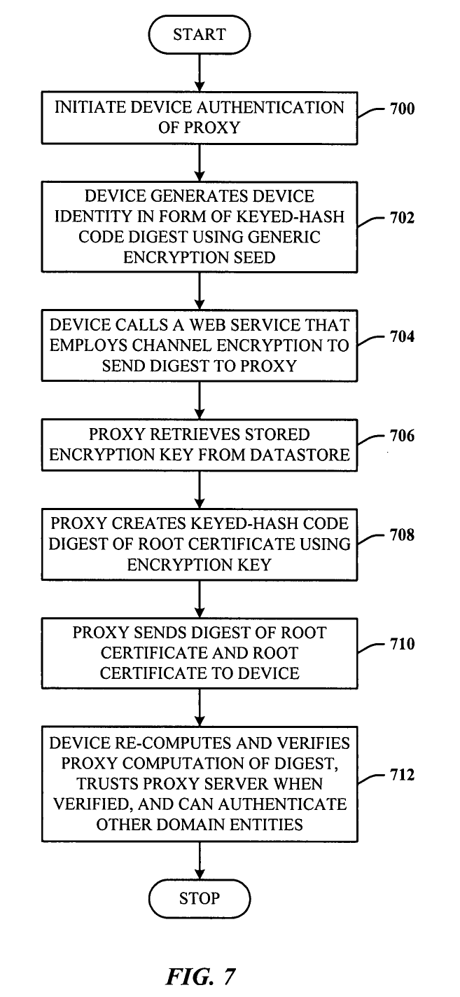

FIG. 7 illustrates a method of enrolling a device (e.g., a mobile phone) by authenticating the proxy. At 700, the device initiates authentication of the proxy to ensure that the proxy is the intended network entity. At 702, the device generates a device identity in the form of a keyed-hash code digest using a generic encryption seed (e.g., user account or other user-identifying information). At 704, the device then calls a web service that employs channel encryption to send the digest to the proxy. The web service can use SSL for channel encryption, but does not yet use SSL authentication. At 706, the proxy then retrieves the previously-stored encryption key from the datastore. At 708, the proxy creates a keyed-hash code digest (e.g., HMAC) of the root certificate of the server's SSL certificate chain. At 710, the proxy sends the digest of the root certificate and the root certificate to the device. At 712, the device verifies that the digest was correctly computed by the proxy, using the root certificate, and by re-computing the digest using the previously-derived device encryption key. Once verified, the device now trusts the proxy as the intended network entity to which the client wishes to communicate.

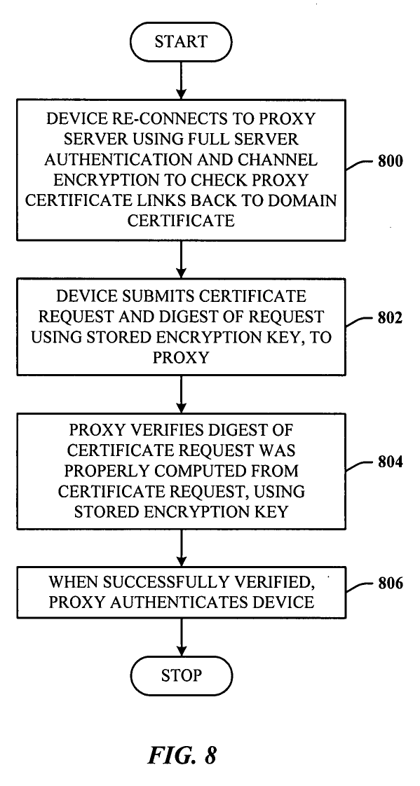

FIG. 8 illustrates a method of authenticating the client to the proxy. Once the device has authenticated the proxy, the proxy, in turn, authenticates the device. At 800, the device re-connects to the proxy using full server authentication (e.g., SSL) with channel encryption to verify that the proxy SSL certificate appropriately links (or chains) back to the domain certificate that was previously determined to be trusted. At 802, the device then submits a certificate request along with a keyed-hash code digest (e.g., HMAC) of the certificate request; the digest derived using the previously-calculated and stored encryption key. At 804, the proxy verifies that the digest of the certificate request was derived from the provided certificate request using the previously-derived encryption key. At 806, when successfully verified, the proxy has authenticated the device.

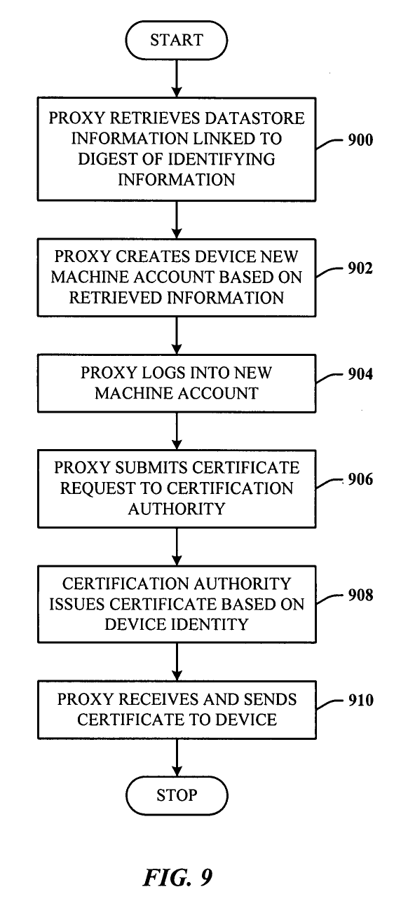

FIG. 9 illustrates a method of obtaining a domain certificate after device and proxy authentication. At 900, the proxy retrieves datastore information linked to digest of identifying information. At 902, the proxy uses the datastore information to create the new machine account in the datastore. At 904, the proxy logs-in to the new machine account. At 906, the proxy submits the certificate request received from the device to the certification authority. At 908, the certification authority issues a signed domain certificate based on the device identity. At 910, the proxy receives and sends issued domain certificate to the device. The device now has full access to the domain services.

It is within contemplation of the subject architecture that the mechanism for obtaining a certificate based on lack of delegated authority to obtain the certificate provides a significant benefit to devices seeking access to a private domain for enterprise services.

A conventional proxy mechanism for obtaining a certificate on behalf of the device is for the proxy to impersonate the device by requesting a password from the device, sending the password to the certification authority, receiving the signed certificate from the authority, and then forwarding the signed certificate to the device.

A novel alternative to the conventional proxy mechanism, that can be thought of as “reverse delegation”, as described herein, is to obtain the certificate in association with a new machine account, and then transfer ownership of the account at the end of the authentication process, thereby providing full access to domain services to the recipient of the certificate, in this case, the device.

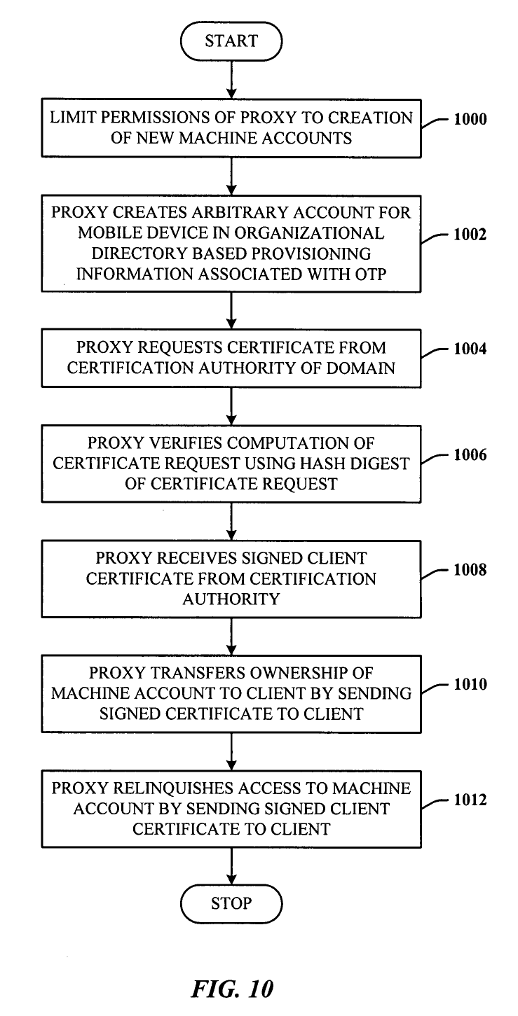

FIG. 10 illustrates a computer-implemented method of obtaining a certificate for domain enrollment. At 1000, proxy permissions are limited to only the creation of new machine accounts. At 1002, the proxy creates an arbitrary machine account for a mobile device in an organizational directory based on provisioning information associated with an OTP. At 1004, the proxy requests a certificate from a certification authority of the domain. At 1006, the proxy verifies computation of a certificate request using a hash digest of the certificate request. At 1008, the proxy receives a signed client certificate from the certification authority. At 1010, the proxy transfers ownership of the machine account to the mobile device by sending the signed certificate to the mobile device. At 1012, the proxy relinquishes access to the machine account after sending the signed client certificate to the client.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

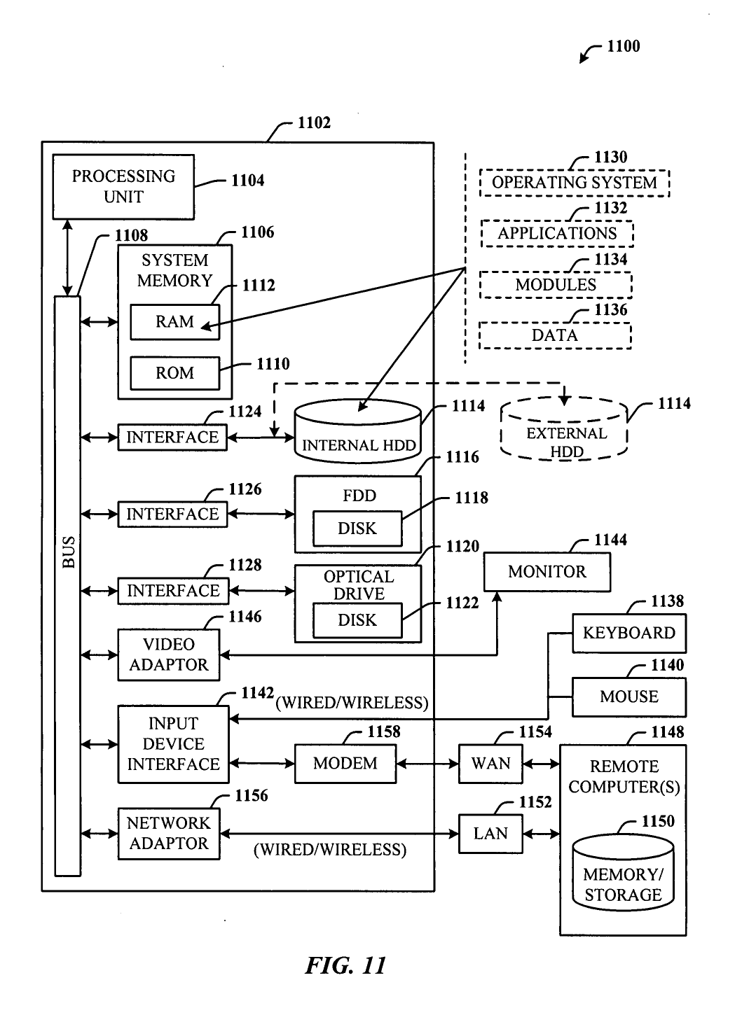

Referring now to FIG. 11, there is illustrated a block diagram of a computing system 100 operable to provide non-secured provisioning and emulated domain join. In order to provide additional context for various aspects thereof, FIG. 11 and the following discussion are intended to provide a brief, general description of a suitable computing system 1100 in which the various aspects can be implemented. While the description above is in the general context of computer-executable instructions that may run on one or more computers, those skilled in the art will recognize that a novel embodiment can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary computing system 1100 for implementing various aspects includes a computer 1102, the computer 1102 including a processing unit 1104, a system memory 1106 and a system bus 1108. The system bus 1108 provides an interface for system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the disclosed methods.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the disclosed architecture can be implemented with various commercially available operating systems or combinations of operating systems.

The applications 1132 and/or modules 1134 can include the proxy server bootstrap and authentication components (108 and 110) of FIG. 1. Where the system 1100 is the client 102, the applications 1132 and/or modules 1134 can include client processing capabilities for generating the encryption key and keyed-hash code digests, for example. In the context of the domain 104 of FIG. 1 and FIG. 2, the system 1100 can include the certification authority 208 and/or the datastore 204 and machine account 206.

A user can enter commands and information into the computer 1102 through one or more wired/wireless input devices, for example, a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, for example, computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

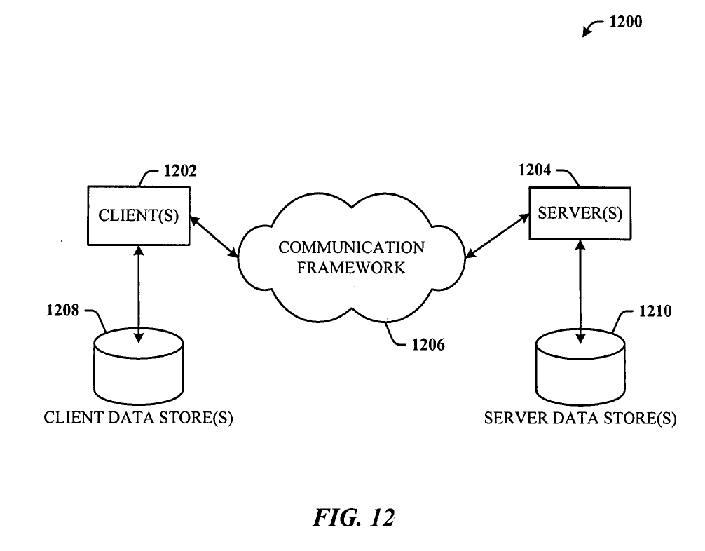

Referring now to FIG. 12, there is illustrated a schematic block diagram of an exemplary computing environment 1200 that facilitates non-secured provisioning and emulated domain join. The system 1200 includes one or more client(s) 1202. The client(s) 1202 can be hardware and/or software (e.g., threads, processes, computing devices). The client(s) 1202 can house cookie(s) and/or associated contextual information, for example.

The system 1200 also includes one or more server(s) 1204. The server(s) 1204 can also be hardware and/or software (e.g., threads, processes, computing devices). The servers 1204 can house threads to perform transformations by employing the architecture, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

The clients 1202 can include the client 102 seeking access to the proxy server 106, both of FIG. 1. The datastore 204 and certification authority 208, both of FIG. 2 can be the servers 1204, which can also be backend servers of an enterprise.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for managing domain membership, comprising:
a bootstrap component of a domain proxy for receiving user credentials from a mobile client seeking access to a domain; and
an authentication component of the proxy for authenticating the mobile client to the domain based on the user credentials.

2. The system of claim 1, wherein the user credentials include at least one of a username or a password.

3. The system of claim 1, wherein the authentication component creates a machine account for the mobile client based on the user credentials.

4. The system of claim 1, wherein the mobile client is of a cell phone that communicates the user credentials over an unsecured air interface.

5. A computer-implemented method of managing domain membership, comprising acts of:
receiving credentials from a mobile device for joining a domain, the credentials received by a proxy server of the domain over an air interface;
establishing a trust relationship between the mobile device and the proxy server based on the credentials;
creating a machine account in the domain for the mobile device via the proxy server and based on the trust relationship; and
joining the mobile device to the domain based on the machine account.

6. The method of claim 5, wherein the credentials include a user name and at least one of a one-time-use password (OTP) or a device ID.

7. The method of claim 5, further comprising receiving a keyed-hash code digest from the mobile device of a generic encryption seed via a web service.

8. The method of claim 7, further comprising receiving the keyed-hash code digest from the web service using channel encryption.

9. The method of claim 5, further comprising generating a keyed-hash code digest of a domain certificate at the proxy server based on an encryption key.

10. The method of claim 5, further comprising sending the keyed-hash code digest and the root certificate to the mobile device for verification by the mobile device and establishing the trust relationship based on successful verification by the mobile device.

11. The method of claim 5, further comprising allowing the mobile client to re-connect to the proxy server using full server authentication with channel encryption for a verification process.

12. The method of claim 5, further comprising verifying that a proxy server certificate links back to a domain certificate associated with a full trust relationship.

13. The method of claim 5, further comprising storing a signed domain certificate on the mobile device as part of an enrollment process.

14. The method of claim 5, further comprising logging-in to the machine account on behalf of the mobile client and submitting a certificate request to a certificate authority of the domain for a signed certificate.

15. The method of claim 14, wherein the signed certificate is returned to the mobile client.

16. The method of claim 5, further comprising storing on a domain datastore at least one of an OTP, an encryption key derived from the OTP, a name for a new machine account, a reference to an owner of the client, a fully qualified domain name of a target container for the new machine account, or a hashed machine authentication code digest of a generic encryption seed derived using the encryption key.

17. The method of claim 5, further comprising discontinuing assistance of the proxy server for the mobile client after the act of joining.

18. The method of claim 5, wherein the trust relationship is a private trust relationship.

19. The method of claim 5, further comprising joining the mobile device to the domain, which is a private domain, based on a machine identity credentials, and not user credentials.

20. A computer-implemented system, comprising:
computer-implemented means for receiving credentials from a mobile device for joining a domain, the credentials received by a proxy server of the domain over an air interface;
computer-implemented means for establishing a trust relationship between the mobile device and the proxy server based on the credentials;
computer-implemented means for creating a machine account in the domain for the mobile device via the proxy server and based on the trust relationship; and
computer-implemented means for joining the mobile device to the domain based on the machine account.
